(19) United States
(12) Patent Application Publication
(10) Pub. No.: US 2003/0157467 A1
(43) Pub. Date: Aug. 21, 2003

(54) Method for teaching the verb in foreign language instruction

(76) Inventor: Lynn C. Lundquist, Porland, OR (US)

Correspondence Address: Lynn Lundquist, 10833 NE Russell, Portland, OR, 97220, US

(21) Appl. No.: 10/076,220

(22) Filed: Feb. 15, 2002

(51) Int. Cl. G09B 19/06; G09B 19/08

(52) U.S. Cl. 434/157

(57) ABSTRACT

The Accelerated Spoken English™ (ASE) course described in this invention emphasizes lesson drills using audiotapes so that students learning English as a second language respond to all language drills audibly. Neither written nor grammar exercises are used. The specific method of this invention arranges each verb into a verb table displaying the infinitive, imperative, and gerund forms of the verb and each person in the past, present and future tenses of the verb. The verb table is then presented to the student as an audible word drill requiring the student to respond with spoken English to each person in three tenses. The drill pattern remains unchanged for each new verb vocabulary word. The method of spoken language drill used to teach the English verb may be applied to any foreign language.

### BACKGROUND

1. Field of this Invention

This invention pertains to the method of teaching the verb of any language to non-native speakers of that language. This method has specific application when teaching English as a Second Language to non-English speaking students. The method is concerned with teaching techniques that accelerate the students' ability to gain fluency in the spoken language. When applied to English language instruction, this is primarily done through the development of a teaching format used to construct spoken drills comprised of grammatically correct and colloquially relevant English sentences. More specifically, this invention deals with the teaching format used to construct spoken drills teaching the English verb.

2. Description of the Prior Art

Most English as a Second Language courses emphasize written lesson exercises rather than spoken English as the primary method for teaching English to non-English speakers. As a consequence, the emphasis of the methodology in English as a Second Language lessons places more emphasis on grammar and related writing skills than on fluency in English speech. Even thought the stated objective is spoken English, the majority of the students' time is spent on non-spoken exercises. Refer to FIGS. 1 and 2 for illustrations of the written drills found in typical English as a Second Language curriculum.

In general, classroom instruction and English as a Second Language textbook design further complicate the lack of training in spoken English in typical English as a Second Language courses. In most instances, the classroom is the setting used for spoken English practice whereas the textbook is used for home study. Thus, most English as a Second Language courses require a high expenditure of the teacher's time in proportion to actual student spoken language practice.

The normal limitations of manual writing speed while doing written assignments further limits the number and kind of non-spoken repetitions students can make in a reasonable amount of time. For this reason, typical English as a Second Language lessons do not drill students on all persons and tenses of each verb in the lesson. Rather, the exercises will randomly select representative person and tense illustrations. Thus, new verbs are not represented to the student's mind as complete entities comprising all of the possible persons and tenses in a uniform pattern that is reproduced for all verbs.

FIG. 1 represents a portion of a written verb drill format frequently encountered in English as a Second Language courses. In this drill—not all of which is shown in FIG. 1—each person of the verb is included; “I,” “he,” “she,” “it,” “you,” “we,” and “they.” The student must then write the corresponding form of the applicable verb in each blank space. However, because the verb is interspersed throughout the exercise, the student does not learn the verb in a recognizable, comprehensive pattern as is the case in FIG. 3. As the end objective of any spoken English course, the student must learn to use the verb in random sentences. However, the first step in learning the verb is best done when all persons and simple tenses of the verb are learned in a logical pattern including all verb components of that language.

FIG. 2, which is taken from another English as a Second Language course, does use a verb table for the verb “to be.” However, this instance is an exception within this particular course of instruction because of the importance of this verb. This course does not present a significant number of verbs in table form.

In the English as a Second Language courses represented in FIGS. 1 and 2, both verb drills are written rather than spoken exercises. In neither course would the student learn the entire verb as a logical and predictable spoken pattern as will be seen in FIGS. 3 and 4.

English as a Second Language is commonly known by its acronym ESL. A modification of English as a Second Language curriculum material is English as a Foreign Language, known by the acronym EFL. English as a Foreign Language is most often taught in countries where English is not a national language. Curriculum development is quite similar to English as a Second Language. However, English as a Foreign Language courses make changes to accommodate a non-native English-speaking teacher.

Some typical English as a Second Language courses as described above are, SIDE BY SIDE published by Prentice Hall Regents, SURVIVAL ENGLISH THROUGH CONVERSATIONS also published by Prentice Hall Regents, A CONVERSATION BOOK again published by Prentice Hall Regents, CLOZE THE GAP published by Alta Book Center, BETTER ENGLISH EVERY DAY published by Holt, Rinehart and Winston, Inc., PRONUNCIATION PAIRS published by Cambridge University Press, YOU SAID IT also published by Cambridge University Press, and ENGLISH, YES! Published by Jamestown Publishers.

### BRIEF DESCRIPTION OF THE DRAWINGS

FIG. 1 is an example of the prior art showing a portion of a written verb exercise.

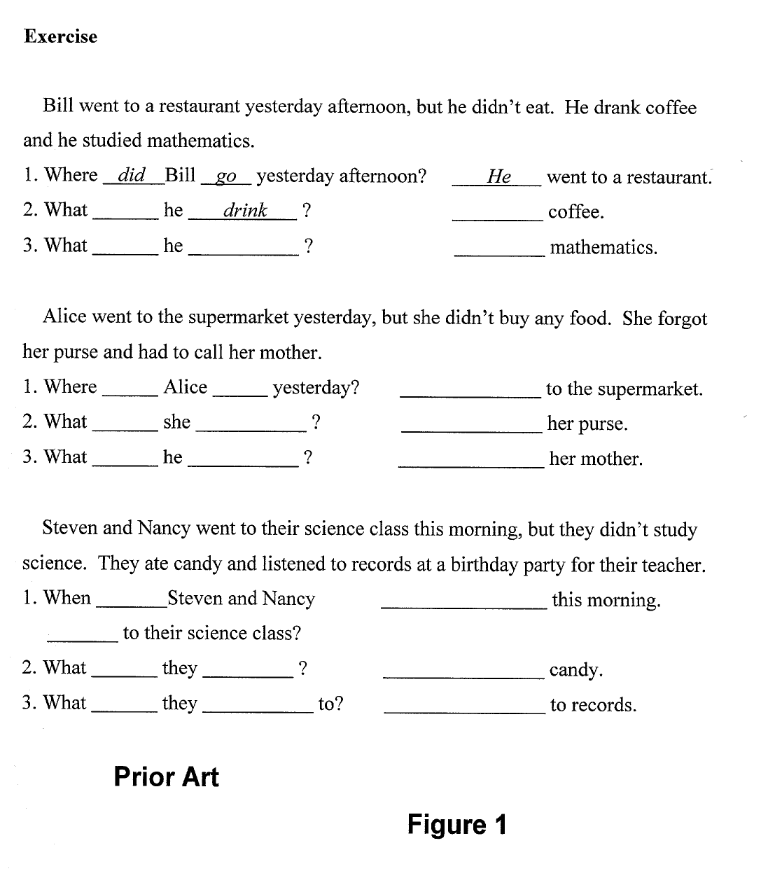

FIG. 2 is another example of the prior art showing a verb table in conjunction with a written exercise.

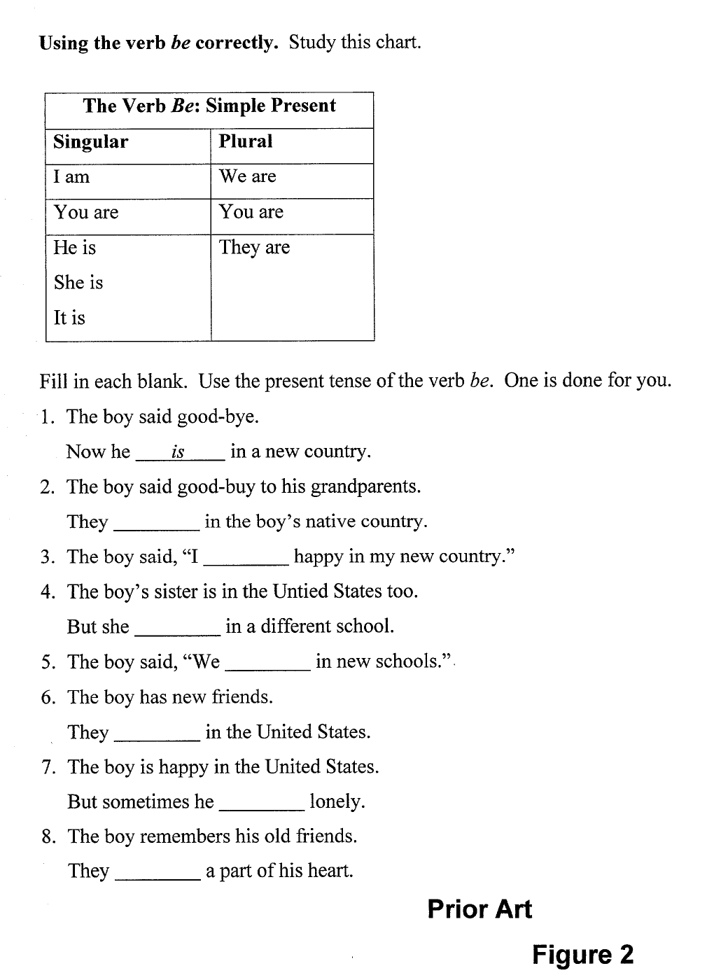

FIG. 3 is an example of a simple verb exercise of this invention in which the students audibly repeat a word drill containing all persons and simple tenses of a verb.

FIG. 4 is an example of a verb exercise of this invention using complete sentences in which the students audibly repeat a word drill containing all persons and simple tenses of a verb.

FIG. 5 is an example of a table from this invention that defines the personal pronoun by its use in a sentence rather than with grammar terms and rules.

FIG. 6 is a portion of a word drill from this invention that teaches the use of the personal pronoun through spoken exercise.

FIG. 7 is an example of a table from this invention that demonstrates proper verb construction.

### IDENTIFICATION OF THIS INVENTION

The term “English as a Second Language” generally identifies the method of instruction as much as the type of instruction. The method of English as a Second Language instruction is typically that of written exercises dealing with vocabulary, grammar, spelling and the like. Throughout this invention we will consider both English as a Second Language and English as a Foreign Language curriculums and methods as being, for our purposes, identical.

In order to avoid confusion and inappropriate identification with English instruction that is quite dissimilar in its method and pace, the teaching method of this invention is identified as Accelerated Spoken English™, or by its acronym ASE.

### OBJECTIVES OF THIS INVENTION

The Accelerated Spoken English™ lessons of this invention were developed to overcome inherent weaknesses within English as a Second Language courses. Those weaknesses are overcome in part by providing an effective method whereby students can work alone on spoken English by using recorded audiotapes in conjunction with printed lessons.

1. It was an objective of the Accelerated Spoken English TM lessons to develop a series of lesson consisting entirely of spoken English without the use of written exercises.

2. Further, it was an objective of the Accelerated Spoken English™ lessons to develop a series of instruction materials consisting entirely of spoken English without the use English grammar instructions.

3. Further, it was an objective of the Accelerated Spoken English™ lessons to develop a student workbook for the series that consisted of written word drills exactly as they are recorded for the audiotape lessons used by the students.

4. Further, it was an objective of the Accelerated Spoken English™ lessons to develop lesson material that allows the students to work independently of the teacher while practicing correctly structured and pronounced spoken English sentences.

5. Further, it was an objective of the Accelerated Spoken English™ lessons to emphasize the English verb. Each new verb was to be taught as a unit including all persons in three tenses.

6. Further, it was an objective of the Accelerated Spoken English™ lessons to develop course progression without writing successive lessons having increased grammatical difficulty. Because the lessons were to emphasize spoken proficiency, later lessons were to be written that did not increase in complexity; they were to be written merely to build vocabulary and increase spoken proficiency.

7. Finally, after incorporating the objectives above, it was an end objective of the Accelerated Spoken English™ lessons to develop a lesson series that taught spoken English more rapidly than is generally done with conventional English as a Second Language courses.

These and other objectives and advantages of the present method, and the manner in which they are achieved, will become apparent in the following specifications and claims.

### SUMMARY OF THIS INVENTION

This method of teaching English as a spoken language is built on a plurality of tenants in addition to the specific methods employed in teaching the English verb. Three directives are given to the students that emphasize the commitment to spoken English as the most effective means of learning the language. These three directives as they appear in the literature of the lessons are as follows:

1. To learn to speak English correctly, you must speak it aloud.

2. To learn to speak English fluently, you must think in English.

3. The more you speak correct English aloud, the more quickly you will learn to speak fluently.

It is thus evident that the methods used in these Accelerated Spoken English™ lessons will use exercises that require the students to speak. Consequently, written student exercises are never used. The students always interact with pre-recorded audiotapes wherein the students either repeat verbatim what the audiotape voice says or respond to the audiotape voice by manipulating a sentence drill.

However, it is also understood that beginning language students do not have sufficient proficiency in the language to construct their own English sentences in order to practice spoken English. Therefore, the audiotapes provide the necessary sentence structure so that the students are always repeating grammatically correct and relevant sentences.

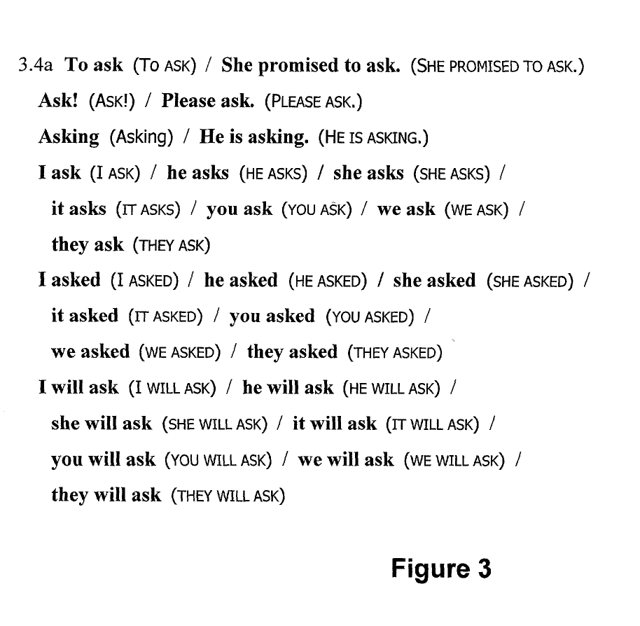

As indicated above, it is a tenant of the Accelerated Spoken English™ lessons that the English learner must think in English. Again, by structuring the language drills as spoken responses to audiotapes, the students are forced to develop their answers in their mind rather than depending on written English sentences. A complete student workbook is provided for the students so that they can initially study the written exercises such as those represented in FIGS. 3, 4, and 6. However, after the students understand the vocabulary and structure of each exercise, they are encouraged to do the exercises without reference to the printed lesson material. This response from memory reinforces thinking in the language which would not take place while reading the response.

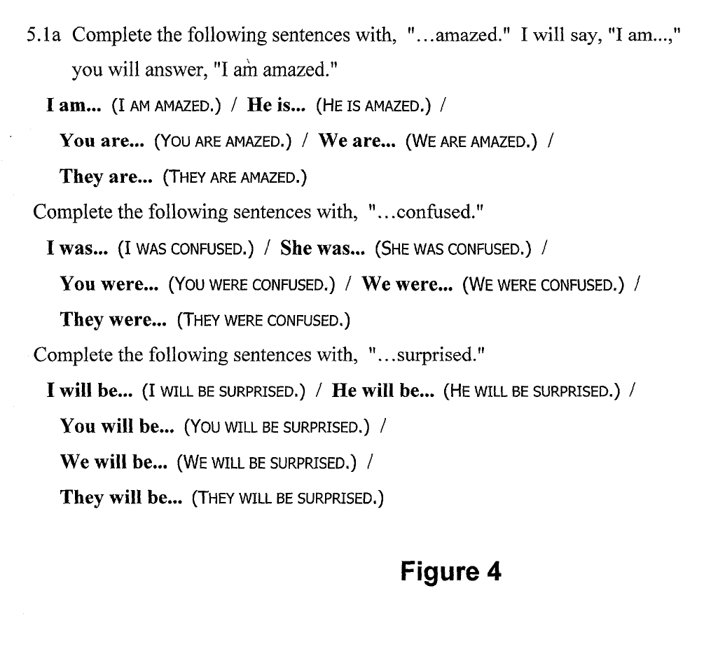

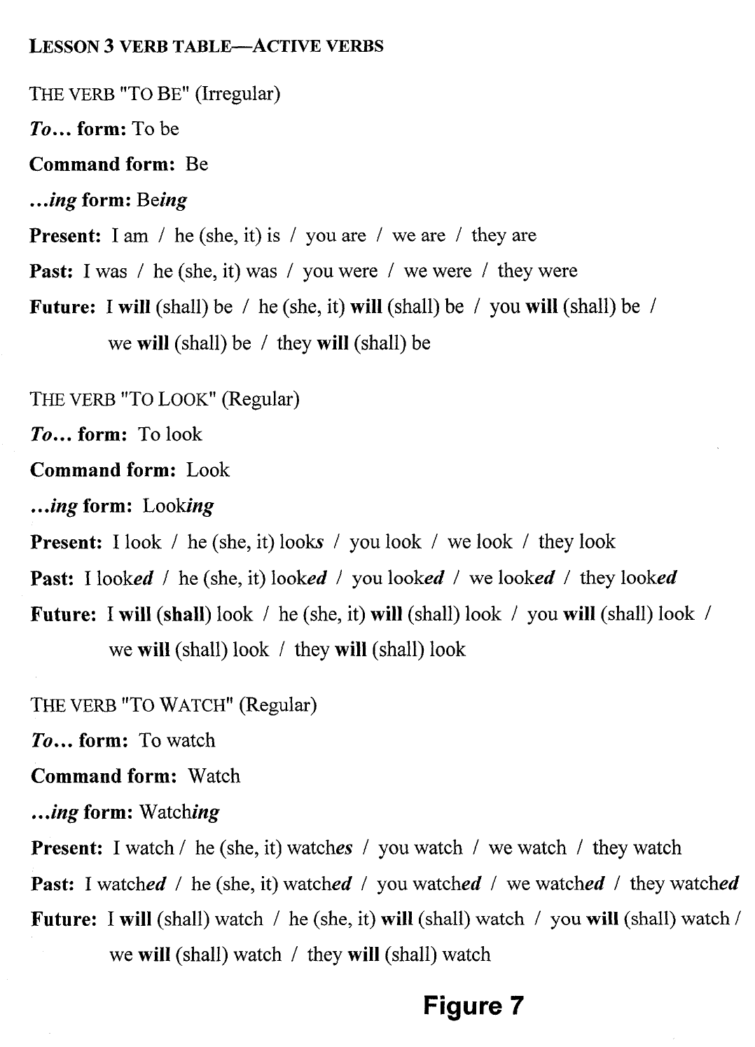

Accelerated Spoken English™ does not teach English grammar by way of stated rules. FIGS. 3 and 4 in conjunction with FIG. 7 illustrate how the entire structure of the English verb is taught solely through spoken drill.

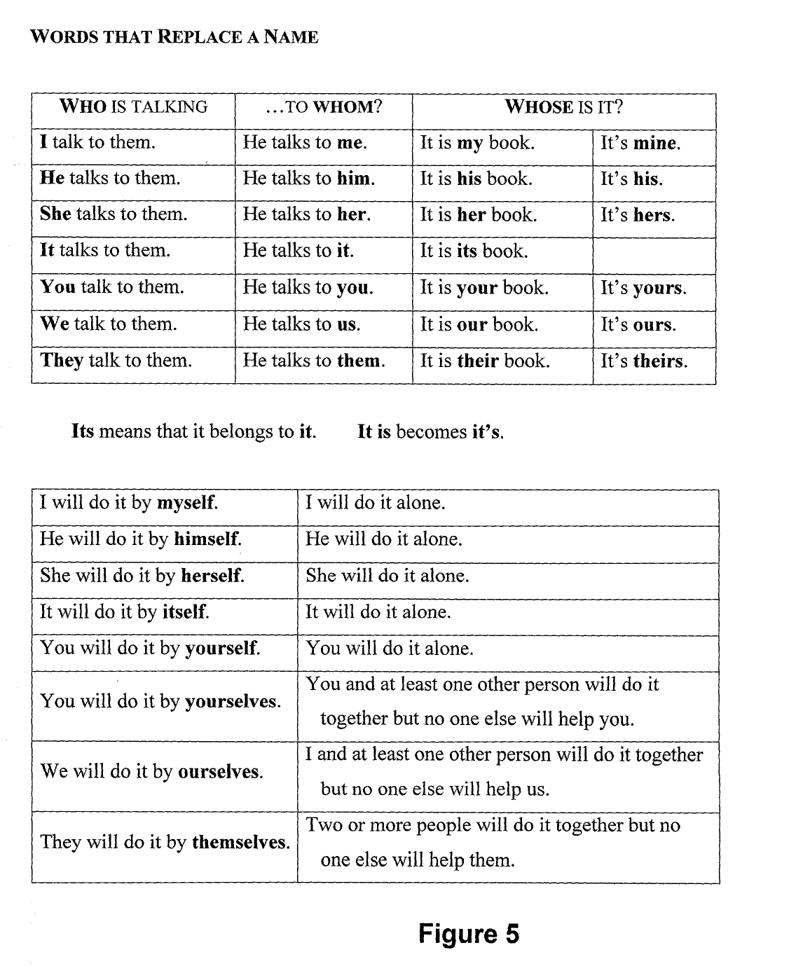

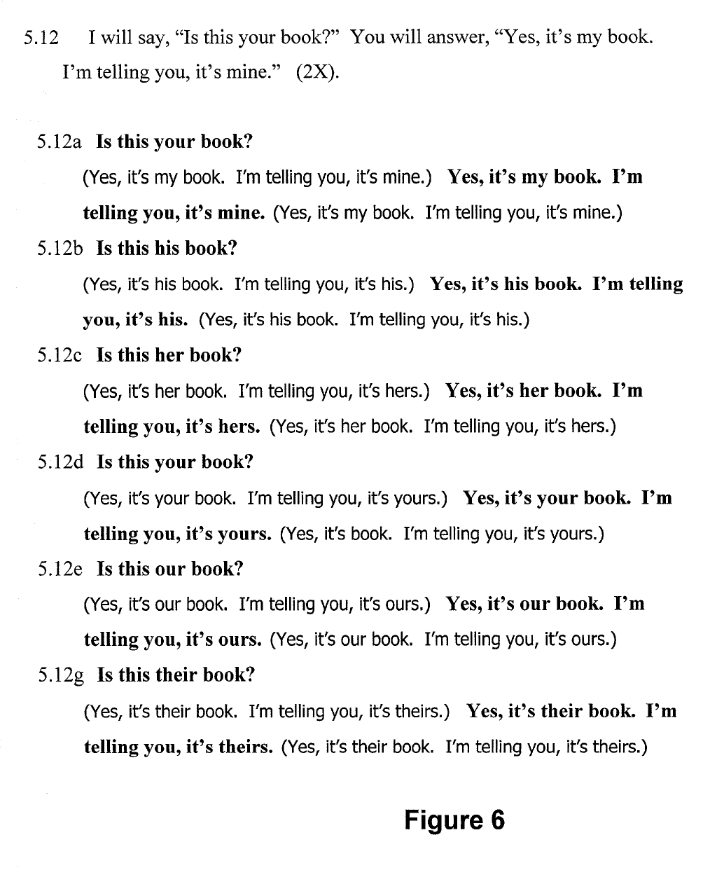

FIG. 5 illustrates another example of the use of spoken drills to teach grammatically correct English. The figure illustrates how the English personal pronoun is taught within the context of normal sentences rather than through grammar instruction. The students will then learn to use the English personal pronoun by repeating spoken drills such as the drill segment shown in FIG. 6.

It would be a false assertion, however, to say that students do not learn English grammar through Accelerated Spoken English™ instruction. When students using this method can properly construct and use English sentences in fluent speech, it can certainly be said that they have mastered English grammar.

Because the students use the audiotapes for their entire personal study time, they are exposed to correct English sentences without requiring a teacher's presence. Thus, another beneficial result of this method is a spoken English course that can effectively be used by students studying alone. As a result, a typical student can study 10 hours or more a week without any teacher supervision.

Because the emphasis of the lessons is spoken fluency, the lessons are not written employing progressively difficult English grammar complexity. Rather, each set of lessons introduces new vocabulary within the context of normal English sentences. Consequently, there is little need to grade the lessons from simple to difficult as the students progress. After the initial introductory lessons, all lessons are essentially similar in complexity. The students could move directly from an early lesson to a lesson at the end of the series without any more difficulty than they would encounter with any new lesson.

A unique quality of these Accelerated Spoken English™ lessons is their method of teaching the English verb. As will be seen under the heading DESCRIPTION OF THE PREFERRED EMBODIMENT, the verb is consistently taught in its entirety in all persons and three tenses using only spoken word drills. In developing the Accelerated Spoken English™ curriculum, a number of unique teaching perspectives and lesson exercises have been incorporated. As each of these individual elements has been combined, however, the end result is a lesson series that has greatly accelerated the students' ability to progress rapidly in the acquisition of spoken English.

### DESCRIPTION OF THE PREFERRED EMBODIMENT

The Accelerated Spoken English™ teaching method is based on the premise that students learn a foreign language best by repetition. However, the beginning English speaker is incapable of learning by repeating sentences that he or she constructs. Since the repetition of correctly constructed English sentences is mandatory for proper language learning, the heart of this series is its use of grammatically correct and colloquially relevant sentences on pre-recorded audiotapes. In this way, from the very first lesson the students can repeat grammatically correct English sentences while practicing.

It can be assumed that beginning students know neither the structure nor the pronunciation of English sentences. The recorded audiotape exercises give both. In all cases, the audiotape speaker's voice gives the proper pronunciation, inflection, and structure of the English sentence while the students listen. Then, the students attempt to mimic each of those elements while repeating the sentence. In most instances, when the students must alter an English sentence, the audiotape speaker gives the correct response allowing additional time for the students to respond a second time. Thus, the students are always given a pattern to follow and an opportunity to check their first response against a second repetition of the correct answer. If the students listen carefully, they can hear all of the necessary elements of the correct English sentence and evaluate their performance against that model.

Actual use of this method can best be seen in FIG. 3 that uses a verb table constructed on the verb “to ask.” When the students are practicing a word drill on the verb “to ask,” the recorded speaker's voice will say, “to ask,” as indicated by the bold text in exercise 3.4a “To ask.” The students will respond by saying, “to ask,” as indicated by the parenthetical wording “(To ASK).” This exercise pattern will continue with the imperative form of the verb “Ask,” the gerund form of the verb “asking,” and subsequently through each person of the simple present, past and future tenses wherein the recorded speaker's voice will say, “I ask,” and the students will respond “(I ask).” The recorded speaker's voice will say, “he asks,” and the students will respond, “(he asks).” Similarly, the students will audibly respond by repeating each person and tense of the verb “to ask” after it is first stated by the recorded speaker's voice.

FIG. 4 shows a further use of this same verb table format. However, as indicated in FIG. 4, the students are instructed to construct a complete sentence with each person and tense of the verb. Thus, in this variation of the verb table format, for exercise 5.1a the recorded speaker's voce will say, “I am,” and the students will respond, “(I am amazed).” Or the recorded speaker's voice will say “he is,” and the students will respond, “(He is amazed).” In a similar pattern, the students will audibly respond by repeating each person and tense of the verb “to be” in a complete sentence after a key word is first stated by the recorded speaker's voice.

Each time that this series of lessons introduces a verb for study, it is developed in a verb table format that is complete in person and tense. Each new verb is always learned in a logical and predictable spoken pattern in which all components of the verb are complete and in which the pattern can be logically transferred to other regular verbs.

The full compliment of English grammar can be taught with spoken drills. FIG. 5 shows the various forms of the English personal pronoun. The use of each of these pronouns can be taught by using spoken exercise drills. FIG. 6 shows a portion of a drill for English possessive pronouns. In this exercise, the students learn to distinguish between “my” and “mine,” “her” and “hers,” ““your” and “yours,” “our” and “ours,” and “their” and “theirs.” For example, in sentence 5.12a the recorded speaker's voice asks, “Is this your book?” The student responds, “(Yes, it's my book. I'm telling you, it's mine.)” Again in sentence 5.12e the recorded speaker's voice asks, “Is this our book?” and the student responds “(Yes, it's our book. I'm telling you, it's ours.)”

The spoken exercise of FIG. 6 is an example of a double repetition drill. In a double repetition drill, the recorded speaker's voice gives a phrase or key word to which the students will respond. After an appropriate pause in which the students have time to state the correct word or sentence, the recorded speaker's voice gives the entire correct phrase. Again, the recorded speaker's voice pauses while the students have opportunity to repeat the correct phrase verbatim. In a double repetition drill, the students have opportunity to say the correct sentence twice.

Though this method was initially developed for teaching spoken English, it is equally applicable to any foreign language instruction. The complete verb of any language, including person, tense, voice, or other components of that language's verb, may be more quickly taught using the verb tables and exercises of this invention. Other language components may equally be taught by spoken repetition rather than by explanations of the grammar of the language or with written exercises.

What I claim is:

1. A method of teaching the verb in foreign language instruction comprising:
a) a first step wherein the verb is presented in a table format including all common persons, tenses, voices and other verb components used within that language;
b) a second step wherein said table format is presented in an identical order of said persons, tenses, voices and other verb components in all instances within said foreign language instruction wherein a verb selected for study occurs;
c) A third step wherein student exercises of the verb repeat each element of said table format.

2. The method of claim 1 wherein said table format includes the verb in a complete sentence.

3. The method of claim 1 wherein said table format presents the infinitive, imperative, gerund, and other forms of the verb used in the language being taught.

4. The method of claim 1 wherein said table format is reproduced on a voice recording medium as spoken drills for the student.

5. The method of claim 1 wherein said table format is reproduced on said voice recording medium and in verbatim printed form permitting said student to follow a printed text.

6. The method of claim 1 wherein said printed text graphically identifies the words spoken by said recorded voice in distinction from the response given by said student.
